(19) United States
(12) Patent Application Publication
(10) Pub. No.: US 2010/0313057 A1
(43) Pub. Date: Dec. 9, 2010

(54) CLOCK SIGNAL TEST APPARATUS AND METHOD

(75) Inventor: TING-CHUNG WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/494,297

(22) Filed: Jun. 30, 2009

(30) Foreign Application Priority Data
Jun. 5, 2009 (CN) 200910302954.7

(51) Int. Cl. G06F 1/06; G06F 11/16

(52) U.S. Cl. 713/500; 714/34; 714/E11.067

(57) ABSTRACT

A clock signal test apparatus for testing a computer system includes a frequency generator to generate a clock pulse signal, a real-time clock (RTC) chip to receive the clock pulse signal from the frequency generator, and a micro control unit (MCU). The MCU is to receive a test command signal from the computer system to set a first current time of the RTC chip equal to a current system time of the computer system, and to receive a time comparing command from the computer system after a test interval to retrieve a second current time of the RTC chip and transmit the second current time of the RTC chip to the computer system.

### BACKGROUND

1. Technical Field

The present disclosure relates to test apparatuses and methods and, particularly, to a clock signal test apparatus and method.

2. Description of Related Art

Real-time clock (RTC) chips are used in computer systems to supply clock signals to the computer systems. Before shipment, the RTC chips must be tested to make sure the clock signals generated by the RTC chips are accurate. Ordinary test methods for testing clock signals of a RTC chip of a computer system are manual, which is very low in efficiency and the result may be inaccurate.

### BRIEF DESCRIPTION OF THE DRAWINGS

FIG. 1 is a block diagram of an exemplary embodiment of a clock signal test apparatus, together with a computer system.

FIG. 2 is a flowchart of an exemplary embodiment of a clock signal test method.

### DETAILED DESCRIPTION

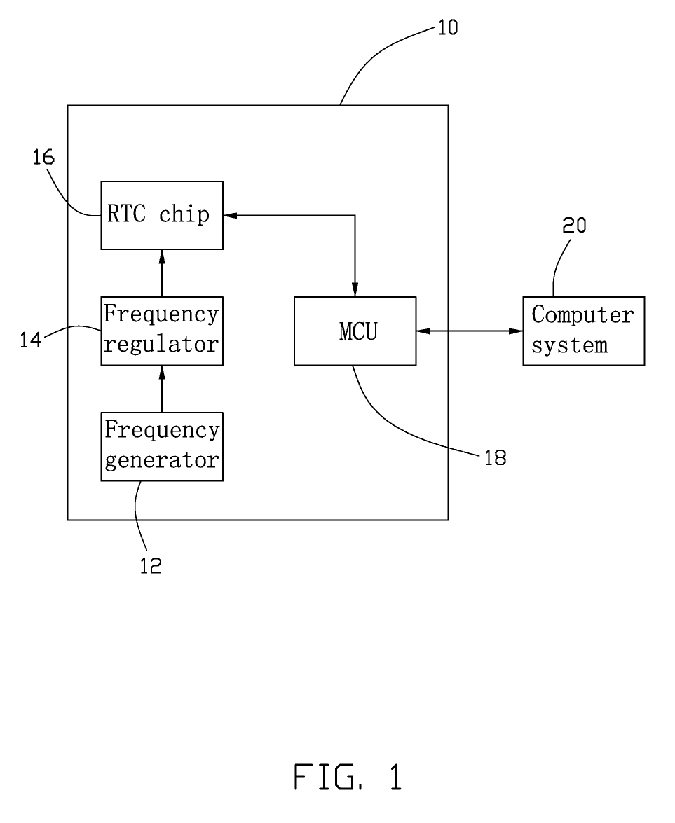

Referring to FIG. 1, an exemplary embodiment of a clock signal test apparatus 10 is used to test clock signals of a computer system 20. The clock signal test apparatus 10 includes a frequency generator 12, a frequency regulator 14, a sample real-time clock (RTC) chip 16 with accurate clock signals, and a micro control unit (MCU) 18.

The frequency generator 12 is to generate a clock pulse signal. The frequency regulator 14 is to receive the clock pulse signal and regulate the frequency of the clock pulse signal to match the RTC chip 16. The RTC chip 16 is to receive the regulated clock pulse signal from the frequency regulator 14 and supply an accurate time signal to the MCU 18. In other embodiments, if the clock pulse signal generated by the frequency generator 12 matches the RTC chip 16, the frequency regulator 14 can be omitted.

The MCU 18 is connected to the computer system 20, to receive a test command signal from the computer system 20. When the MCU 18 receives the test command signal, the computer system 20 retrieves a first current system time T1 of the computer system 20 and transmits the system time T1 to the MCU 18. The MCU 18 receives the system time T1 and sets a first current time of the RTC chip 16 equal to the system time T1 of the computer system 20 according to the test command signal. After a test interval (such as six hours), the computer system 20 outputs a time comparing command to the MCU 18 and retrieves a second current system time T2 of the computer system 20. When the MCU 18 receives the time comparing command, the MCU 18 retrieves a second current time T3 of the RTC chip 16 and transmits the time T3 of the RTC chip 16 to the computer system 20. The computer system 20 calculates an error M of the system time of the computer system 20 according to the system time T1, the system time T2 of the computer system 20, and the time T3 of the RTC chip 16. M is calculated as: M=[(T2−T3)/(T3−T1)]. Testers can determine whether the error M is within a standard range according to the result of the above formula. During the test interval, the testers can operate the computer system 20 or do another test for the computer system 20 as long as the computer system 20 is not turned off.

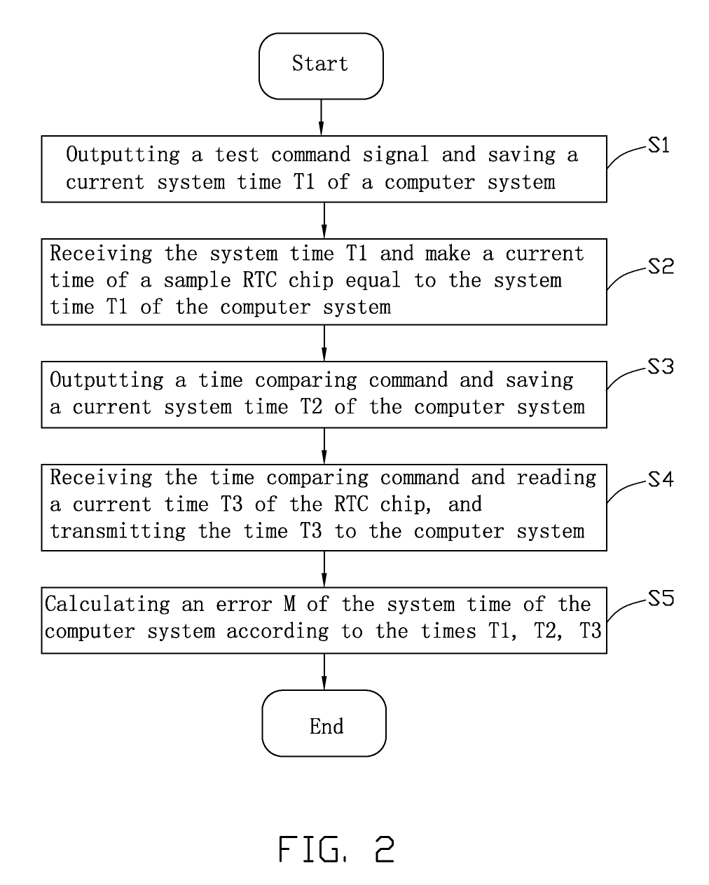

Referring to FIG. 2, an exemplary embodiment of a clock signal test method used in the clock signal test apparatus 10 includes the following steps.

In step SI, the computer system 20 outputs a test command signal to the MCU 18 and retrieves a first current system time T1 of the computer system 20.

In step S2, the MCU 18 receives the system time T1 and sets a first current time of the RTC chip 16 equal to the system time T1 of the computer system 20 according to the test command signal.

In step S3, after a test interval, the computer system 20 outputs a time comparing command to the MCU 18 and retrieves a second current system time T2 of the computer system 20.

In step S4, the MCU 18 receives the time comparing command and retrieves a second current time T3 of the RTC chip 16, and transmits the time T3 of the RTC chip 16 to the computer system 20.

In step S5, the computer system 20 calculates an error M of the system time of the computer system 20 according to the system time T1, the system time T2 of the computer system 20, and the time T3 of the RTC chip 16. M is calculated as: M=[(T2−T3)/(T3−T1)].

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A clock signal test apparatus for a computer system, the clock signal test apparatus comprising:
a frequency generator to generate a clock pulse signal;
a real-time clock (RTC) chip to receive the clock pulse signal from the frequency generator; and
a micro control unit (MCU) to receive a test command signal from the computer system to set a first current time of the RTC chip equal to a current system time of the computer system, and to receive a time comparing command from the computer system after a test interval to retrieve a second current time of the RTC chip and transmit the second current time of the RTC chip to the computer system.

2. The clock signal test apparatus of claim 1, further comprising a frequency regulator connected between the frequency generator and the RTC chip, to regulate the frequency of the clock pulse signal to match the RTC chip.

3. A clock signal test method for a computer system, the method comprising:
the computer system outputting a test command signal to a micro control unit (MCU), and retrieving a first current system time T1 of the computer system;
the MCU receiving the system time T1 to set a first current time of a real-time clock (RTC) chip equal to the system time T1 of the computer system according to the test command signal;
after a test interval, the computer system outputting a time comparing command to the MCU and retrieving a second current system time T2 of the computer system;
the MCU receiving the time comparing command and retrieving a second current time T3 of the RTC chip, and transmitting the current time T3 of the RTC chip to the computer system; and
the computer system calculating an error M of the system time of the computer system according to the system time T1, the system time T2 of the computer system, and the time T3 of the RTC chip.

4. The clock signal test method of claim 3, wherein M is calculated as: M=[(T2−T3)/(T3−T1)].
